(19) United States
(12) Patent Application Publication
(10) Pub. No.: US 2026/0200534 A1
(43) Pub. Date: Jul. 16, 2026

(54) VEHICLE SKELETON STRUCTURE

(71) Applicant: TOYOTA JIDOSHA KABUSHIKI KAISHA, Toyota-shi (JP)

(72) Inventors: Ayaka KAGAMI, Inazawa-shi (JP); Soshiro MURATA, Toyota-shi (JP)

(73) Assignee: TOYOTA JIDOSHA KABUSHIKI KAISHA, Toyota-shi (JP)

(21) Appl. No.: 19/428,606

(22) Filed: Dec. 22, 2025

(30) Foreign Application Priority Data
Jan. 16, 2025 (JP) 2025-006385

(51) Int. Cl. B62D 25/14; B62D 25/18

(52) U.S. Cl. CPC B62D 25/14; B62D 25/18

(57) ABSTRACT

A vehicle skeleton structure includes: a front skeleton main body integrally formed by casting, the front skeleton main body including a dash portion that is disposed at a vehicle front portion and that extends in a vehicle width direction, and a front-rear extending portion that extends from the dash portion toward a vehicle front side and that includes an opening at one side in the vehicle width direction; and a cover member that is attached to the front-rear extending portion and that covers at least part of the opening from the vehicle width direction.

### CROSS-REFERENCE TO RELATED APPLICATION

This application is based on and claims priority under 35 USC 119 from Japanese Patent Application No. 2025-006385, filed on January 16, 2025, the entire disclosure of which is incorporated by reference herein.

### BACKGROUND

### Technical Field

The present disclosure relates to a vehicle skeleton structure.

### Related Art

Chinese Utility Model Publication No. 217496272 discloses a structure in which a skeleton at a vehicle front portion is configured by a die-cast component that is integrally formed by casting.

In a structure in which a skeleton at a vehicle front portion is integrally formed by casting, as in the structure described in Chinese Utility Model Publication No. 217496272, a portion corresponding to a front side member or a portion corresponding to a crash box has an open cross-sectional shape that is open at one side in a vehicle width direction. In this case, as compared to a case in which the skeleton is configured with a closed cross-section, the cross-section is likely to collapse when a collision load is input.

### SUMMARY

The present disclosure provides a vehicle skeleton structure in which a skeleton at a vehicle front portion is formed by casting, and enables cross-sectional collapse to be suppressed when a collision load is input.

A vehicle skeleton structure according to a first aspect includes: a front skeleton main body integrally formed by casting, the front skeleton main body including a dash portion that is disposed at a vehicle front portion and that extends in a vehicle width direction, and a front-rear extending portion that extends from the dash portion toward a vehicle front side and that includes an opening at one side in the vehicle width direction; and a cover member that is attached to the front-rear extending portion and that covers at least part of the opening from the vehicle width direction.

In the vehicle skeleton structure according to the first aspect, the front skeleton main body is integrally formed by casting and includes the dash portion and the front-rear extending portion that extends from the dash portion toward the vehicle front side. Moreover, the front-rear extending portion includes an opening at one side in the vehicle width direction, and at least part of the opening is covered from the vehicle width direction by the cover member. This enables opening of the opening of the front-rear extending portion to be suppressed even in a case in which the front skeleton main body is formed by casting.

A vehicle skeleton structure according to a second aspect is the vehicle skeleton structure according to the first aspect, wherein: the front-rear extending portion includes an upper plate portion that is disposed at a vehicle upper side, a lower plate portion that is disposed at a vehicle lower side, and a middle plate portion that is disposed between the upper plate portion and the lower plate portion; and the cover member covers from the upper plate portion to the lower plate portion.

In the vehicle skeleton structure according to the second aspect, the front-rear extending portion includes the upper plate portion, the lower plate portion, and the middle plate portion, and the cover member covers from the upper plate portion to the lower plate portion. This enables the entirety of the opening to be covered when viewed from the vehicle front-rear direction, enabling a closed cross-sectional structure to be obtained.

A vehicle skeleton structure according to a third aspect is the vehicle skeleton structure according to the second aspect, wherein: the front-rear extending portion includes a longitudinal rib that partitions the opening into a front and a rear; and the cover member is mechanically fastened at least at a connecting portion of the longitudinal rib and the upper plate portion and at a connecting portion of the longitudinal rib and the lower plate portion.

In the vehicle skeleton structure according to the third aspect, the opening of the front-rear extending portion is partitioned into a front and rear by the longitudinal rib. Moreover, the cover member is mechanically fastened at least at a connecting portion between the longitudinal rib and the upper plate portion, and at a connecting portion between the longitudinal rib and the lower plate portion. This enables the fastening to be firmly performed in comparison to a structure in which fastening is performed at a position at which the longitudinal rib is not provided.

A vehicle skeleton structure according to a fourth aspect is the vehicle skeleton structure according to the third aspect, wherein: plural longitudinal ribs are formed at intervals in a vehicle front-rear direction; and the cover member is provided with a fragile portion at a position between adjacent longitudinal ribs.

In the vehicle skeleton structure according to the fourth aspect, since the fragile portion is provided at the cover member, at a position between adjacent longitudinal ribs, when the front-rear extending portion breaks due to a vehicle collision, the cover member does not inhibit breaking of the front-rear extending portion, enabling the collision energy to be effectively absorbed.

A vehicle skeleton structure according to a fifth aspect is the vehicle skeleton structure according to the second aspect, wherein the cover member includes: a main body portion that covers the opening; an upper flange portion that extends from an upper end portion of the main body portion in the vehicle width direction and that is fastened in a state superposed on the upper plate portion; and a lower flange portion that extends from a lower end portion of the main body portion in the vehicle width direction and that is fastened in a state superposed on the lower plate portion.

In the vehicle skeleton structure according to the fifth aspect, the upper flange portion of the cover member is fastened in a state superposed on the upper plate portion, and the lower flange portion is fastened in a state superposed on the lower plate portion. This enables the fastening direction of the cover member to be in the vehicle up-down direction, enabling the fastening state to be maintained satisfactorily even in a case in which an external force in the up-down direction is input.

As described above, the vehicle skeleton structure according to the present disclosure enables cross-sectional collapse to be suppressed when a collision load is input in a structure in which the skeleton at the vehicle front portion is formed by casting.

### BRIEF DESCRIPTION OF THE DRAWINGS

Exemplary embodiments of the present disclosure will be described in detail based on the following figures, wherein:

FIG. 1 is an exploded perspective view illustrating the main parts of a vehicle skeleton structure according to an exemplary embodiment;

FIG. 2 is a side view illustrating the main parts of a vehicle skeleton structure according to an exemplary embodiment;

FIG. 3 is an enlarged cross-sectional view illustrating a state along the line 3-3 in FIG. 2 in an enlarged manner;

FIG. 4 is an enlarged cross-sectional view illustrating a state along the line 4-4 in FIG. 2 in an enlarger manner; and

FIG. 5 is an enlarged cross-sectional view corresponding to FIG. 3, illustrating the main parts of a vehicle skeleton structure according to a modified example.

### DETAILED DESCRIPTION

Explanation follows regarding a vehicle skeleton structure according to an exemplary embodiment, with reference to the drawings.

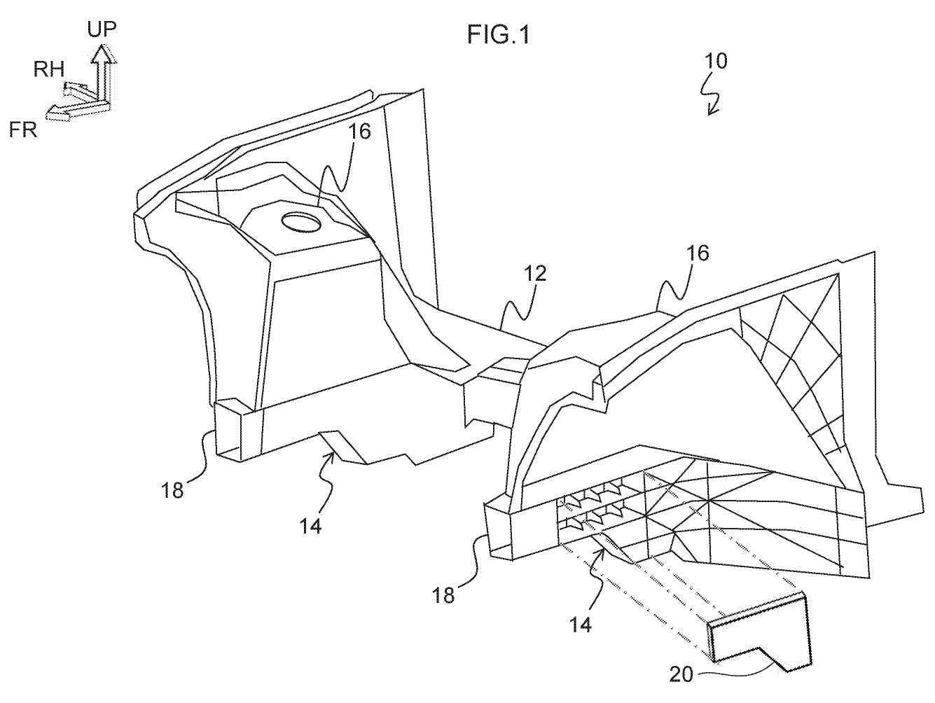

FIG. 1 is a perspective view illustrating the main parts of a vehicle skeleton structure according to an exemplary embodiment. Note that in the drawings, the arrow FR, the arrow UP, the arrow RH, and the arrow LH respectively indicate a vehicle frontward direction, a vehicle upward direction, a vehicle right direction, and a vehicle left direction of a vehicle. In the following explanation, in cases in which front-rear, up-down, and left-right directions are described without any particular notation to the contrary, these indicate front and rear in a vehicle front-rear direction, up and down in a vehicle up-down direction, and left and right in a vehicle left-right direction (width direction), respectively.

As illustrated in FIG. 1, the front skeleton main body 10 that configures a vehicle skeleton structure is a component disposed at a front portion of a vehicle, and is formed by casting. The front skeleton main body 10 of the present exemplary embodiment is a die-cast component that mainly includes an aluminum alloy and that is integrally formed by casting, and that includes a dash portion 12, a front-rear extending portion 14, and a suspension tower portion 16.

The dash portion 12 extends in the vehicle width direction, and configures a part of a member that partitions a vehicle cabin space and the outside of the vehicle cabin (power unit room).

Front-rear extending portions 14 respectively extend from both end portions, in the vehicle width direction, of the dash portion 12 toward a vehicle front side. The front-rear extending portion 14 of the present exemplary embodiment is, for example, a portion corresponding to a front side member. Details of the front-rear extending portion 14 are described below.

The suspension tower portion 16 is provided above the front-rear extending portion 14. Similarly to the front-rear extending portions 14, a left and right pair of suspension tower portions 16 is provided, the suspension tower portions 16 respectively bulge out toward a vehicle upper side, and a configuration is one in which the illustrated suspension can be supported.

A connecting portion 18 having a substantially rectangular cylindrical shape is provided at a front end portion of the front-rear extending portion 14. A rear end portion of the connecting portion 18 is fixed to the front-rear extending portion 14, and a frame, which is not illustrated in the drawings, is connected to a front end portion of the connecting portion 18. Moreover, a bumper reinforcement that extends in the vehicle width direction is attached to the frame.

Note that the front-rear extending portion 14 is formed in an open cross-sectional shape with an opening provided at one side in the vehicle width direction, and has a structure in which at least part of the opening of the front-rear extending portion 14 is covered by a cover member 20. As an example, in the present exemplary embodiment, the front-rear extending portion 14 is formed in a shape in which a vehicle width direction outer side is opened, and the cover member 20 is attached to the front-rear extending portion 14 from the the vehicle width direction outer side.

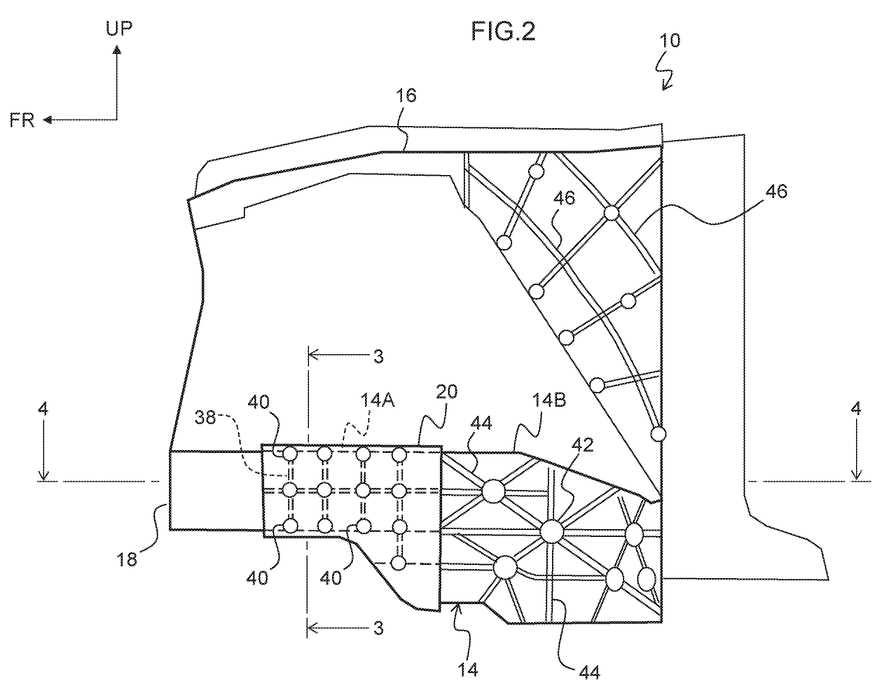

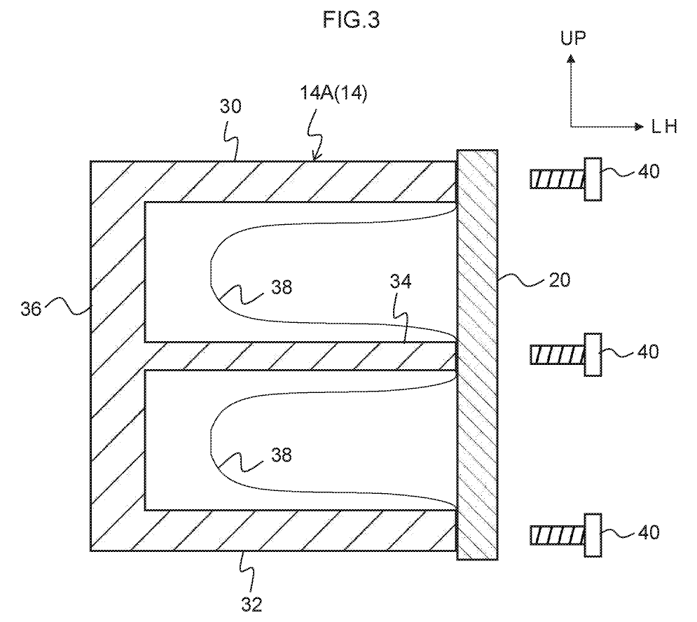

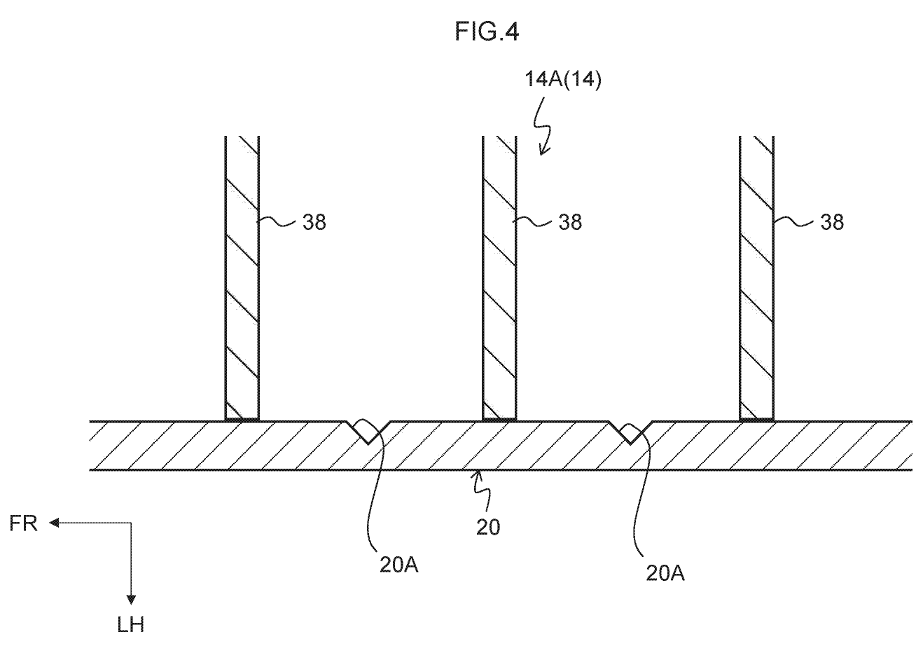

FIG. 2 is a side view illustrating the main parts of the vehicle skeleton structure according to an exemplary embodiment, FIG. 3 is an enlarged cross-sectional view illustrating a state along the line 3-3 in FIG. 2 in an enlarged manner, and FIG. 4 is an enlarged cross-sectional view illustrating a state along the line 4-4 in FIG. 2 in an enlarged manner. As illustrated in FIG. 2, the front-rear extending portion 14 includes a front side member front portion 14A and a front side member rear portion 14B.

The front side member front portion 14A configures a front portion of the front-rear extending portion 14, and is formed in a shape in which a rear portion is longer than a front portion in the vehicle up-down direction. Moreover, the front side member front portion 14A and the front side member rear portion 14B are integrally formed in a continuous manner.

The front side member rear portion 14B has an open cross-sectional structure in which a vehicle width direction outer side is open, and plural reservoirs 42 are provided within the cross-section. Moreover, the front side member rear portion 14B is provided with plural ribs 44 connecting the reservoirs 42 and upper and lower wall portions. The ribs 44 provided at the front side member rear portion 14B include ribs extending in the vehicle up-down direction, ribs extending in the vehicle front-rear direction, and ribs extending obliquely.

As illustrated in FIG. 3, the front side member front portion 14A is formed with a substantially E-shaped cross-section when viewed from the vehicle front-rear direction. More specifically, the front side member front portion 14A includes an upper plate portion 30, a lower plate portion 32, a middle plate portion 34, and a vertical wall portion 36.

The upper plate portion 30 is disposed at the vehicle upper side, and extends in the vehicle width direction and in the vehicle front-rear direction with the vehicle up-down direction serving as a plate thickness direction. The lower plate portion 32 is positioned below the upper plate portion 30, and extends in the vehicle width direction and in the vehicle front-rear direction with the vehicle up-down direction serving as the plate thickness direction.

The middle plate portion 34 is disposed between the upper plate portion 30 and the lower plate portion 32, and extends in the vehicle width direction and in the vehicle front-rear direction with the vehicle up-down direction serving as the plate thickness direction. Moreover, the vertical wall portion 36 extends in the vehicle up-down direction and in the vehicle front-rear direction with the vehicle width direction serving as the plate thickness direction, and vertically connects vehicle width direction inner side end portions of the upper plate portion 30, the lower plate portion 32, and the middle plate portion 34, respectively.

Note that the front side member front portion 14A is provided with plural longitudinal ribs 38. The longitudinal ribs 38 are respectively provided between the upper plate portion 30 and the middle plate portion 34, and between the lower plate portion 32 and the middle plate portion 34, and partition the opening in the vehicle front-rear direction. Note that as an example, the longitudinal ribs 38 of the present exemplary embodiment are integrally formed together with the front-rear extending portion 14 by casting, and although a central portion in the up-down direction is recessed inward in the vehicle width direction, there is no limitation thereto. For example, a shape in which the length in the vehicle width direction does not change from an upper end to a lower end may be adopted.

As illustrated in FIG. 2, the longitudinal ribs 38 are disposed at intervals in the vehicle front-rear direction, and a reservoir, which is not illustrated in the drawings, is formed at a connecting portion between the longitudinal rib 38 and the upper plate portion 30. Similarly, a reservoir, which is not illustrated in the drawings, is formed at a connecting portion between the longitudinal rib 38 and the middle plate portion 34, and at a connecting portion between the longitudinal rib 38 and the lower plate portion 32.

As illustrated in FIG. 3, the cover member 20 is configured by a metal plate or the like with the vehicle width direction serving as the plate thickness direction, and the length of the cover member 20 in the vehicle up-down direction is slightly longer than the front side member front portion 14A. Moreover, the shape of the cover member 20 corresponds to the shape of the front side member front portion 14A (see FIG. 2).

The cover member 20 is mechanically fastened by plural bolts 40 in a state in which the cover member 20 is superposed from a vehicle width direction outer side of the front side member front portion 14A so as to cover from the upper plate portion 30 to the lower plate portion 32. Although the bolts 40 are screwed to the upper plate portion 30, the middle plate portion 34, and the lower plate portion 32 in the present exemplary embodiment as an example, there is no limitation thereto, and fastening by the bolts 40 may be performed at two positions above and below the upper plate portion 30 and the lower plate portion 32.

As illustrated in FIG. 4, the cover member 20 is provided with plural fragile portions 20A. The fragile portion 20A is provided at a position between adjacent longitudinal ribs 38, and has a shape in which a vehicle width direction surface of the cover member 20 is locally thinned. Although, in the present exemplary embodiment, the fragile portion 20A is provided with a shape cut out in an approximate V-shape as an example, there is no limitation thereto, and any other shape may be adopted as long as the structure becomes fragile.

As illustrated in FIG. 2, plural ribs 46 are provided in a region at a rear portion of the suspension tower portion 16.

Next, explanation follows regarding operation of the vehicle skeleton structure according to the present exemplary embodiment.

As illustrated in FIG. 1, the front skeleton main body 10 according to the present exemplary embodiment is integrally formed by casting, and includes the dash portion 12 and the front-rear extending portion 14 that extends from the dash portion 12 toward the vehicle front side. Moreover, the front-rear extending portion 14 is provided with an opening at one side in the vehicle width direction, and at least a part of the opening is covered from the vehicle width direction by the cover member 20. This enables opening of the opening of the front-rear extending portion 14 to be suppressed even in a case in which the front skeleton main body 10 is formed by casting. Namely, in a structure in which the skeleton of the vehicle front portion is formed by casting, cross-sectional collapse can be suppressed when a collision load is input.

As illustrated in FIG. 3, in the present exemplary embodiment, the front-rear extending portion 14 includes the upper plate portion 30, the lower plate portion 32, and the middle plate portion 34, and the cover member 20 covers from the upper plate portion 30 to the lower plate portion 32. This enables the entirety of the opening to be covered when viewed from the vehicle front-rear direction, enabling a closed cross-sectional structure to be obtained.

In the present exemplary embodiment, the opening of the front-rear extending portion 14 is partitioned into a front and a rear by the longitudinal ribs 38. Moreover, the cover member 20 is mechanically fastened at least at a connecting portion between the longitudinal rib 38 and the upper plate portion 30, and at a connecting portion between the longitudinal rib 38 and the lower plate portion 32. This enables the fastening to be firmly performed in comparison to a structure in which fastening is performed at a position at which the longitudinal ribs 38 are not provided.

Moreover, as illustrated in FIG. 4, in the present exemplary embodiment, since the fragile portion 20A is provided at the cover member 20, at a position between adjacent longitudinal ribs 38, when the front-rear extending portion 14 breaks due to a vehicle collision, the cover member 20 does not inhibit breaking of the front-rear extending portion 14, enabling the collision energy to be effectively absorbed.

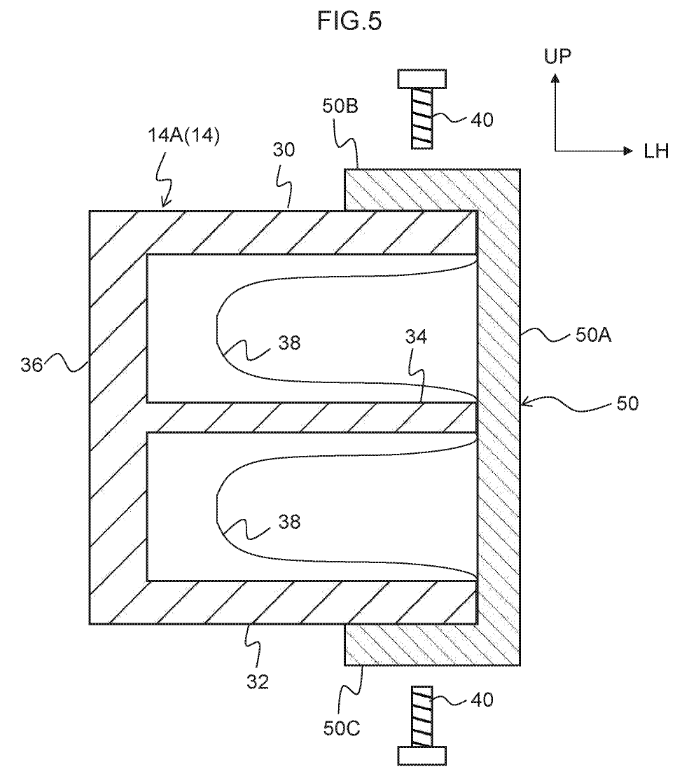

Note that although the cover member 20 is formed in a flat plate shape in the present exemplary embodiment, there is no limitation thereto. For example, the structure of the modified example illustrated in FIG. 5 may be adopted.

FIG. 5 is an enlarged cross-sectional view corresponding to FIG. 3, illustrating the main parts of a vehicle skeleton structure according to a modified example. As illustrated in FIG. 5, the configuration of the present modified example is similar to the configuration of the exemplary embodiment, with the exception of the cover member 50.

The cover member 50 includes a main body portion 50A, an upper flange portion 50B, and a lower flange portion 50C. The main body portion 50A extends in the vehicle up-down direction and in the vehicle front-rear direction with the vehicle width direction serving as a plate thickness direction, and covers the opening of the front-rear extending portion 14 from the vehicle width direction outer side.

The upper flange portion 50B extends inward in the vehicle width direction from an upper end of the main body portion 50A, and is mechanically fastened from the vehicle upper side by the bolt 40 in a state in which the upper flange portion 50B is superposed on an upper surface of the upper plate portion 30.

The lower flange portion 50C extends inward in the vehicle width direction from a lower end of the main body portion 50A, and is mechanically fastened from the vehicle lower side by the bolt 40 in a state in which the lower flange portion 50C is superposed on a lower surface of the lower plate portion 32. Accordingly, in the exemplary embodiment, the front-rear extending portion 14 and the cover member 20 are fastened in the vehicle width direction by the bolts 40, while in the present modified example, the front-rear extending portion 14 and the cover member 50 are fastened in the vehicle up-down direction by the bolts 40.

Note that in the present modified example, similarly to the exemplary embodiment, bolts may be provided to fasten the front-rear extending portion 14 and the cover member 50 in the vehicle width direction. In this case, the front-rear extending portion 14 and the cover member 50 are fastened in the vehicle width direction and in the vehicle up-down direction.

Although explanation has been given regarding the vehicle skeleton structure according to the present disclosure, obviously various embodiments may be implemented within a range not departing from the gist of the present disclosure. Although in the present exemplary embodiment, as illustrated in FIG. 2, the cover member 20 is attached only to the front side member front portion 14A of the front-rear extending portion 14, there is no limitation thereto, and the cover member 20 may be attached at another location. For example, cover members may be attached to both the front side member front portion 14A and the front side member rear portion 14B. Alternatively, a cover member may be attached to a region provided with the ribs 46 of the rear portion of the suspension tower portion 16.

Although in the present exemplary embodiment, the substantially rectangular cylindrical connecting portion 18 is provided at the front end portion of the front-rear extending portion 14, there is no limitation thereto. For example, the front-rear extending portion 14 may be integrally formed by casting so as to extend up to the region of the connecting portion 18. In this case, the portion corresponding to the connecting portion has an open cross-sectional shape, similarly to the front-rear extending portion 14.

What is claimed is:

1. A vehicle skeleton structure, comprising:
a front skeleton main body integrally formed by casting, the front skeleton main body including a dash portion that is disposed at a vehicle front portion and that extends in a vehicle width direction, and a front-rear extending portion that extends from the dash portion toward a vehicle front side and that includes an opening at one side in the vehicle width direction; and
a cover member that is attached to the front-rear extending portion and that covers at least part of the opening from the vehicle width direction.

2. The vehicle skeleton structure according to claim 1, wherein:
the front-rear extending portion includes an upper plate portion that is disposed at a vehicle upper side, a lower plate portion that is disposed at a vehicle lower side, and a middle plate portion that is disposed between the upper plate portion and the lower plate portion; and
the cover member covers from the upper plate portion to the lower plate portion.

3. The vehicle skeleton structure according to claim 2, wherein:
the front-rear extending portion includes a longitudinal rib that partitions the opening into a front and a rear; and
the cover member is mechanically fastened at least at a connecting portion of the longitudinal rib and the upper plate portion and at a connecting portion of the longitudinal rib and the lower plate portion.

4. The vehicle skeleton structure according to claim 3, wherein:
a plurality of longitudinal ribs are formed at intervals in a vehicle front-rear direction; and
the cover member is provided with a fragile portion at a position between adjacent longitudinal ribs.

5. The vehicle skeleton structure according to claim 2, wherein the cover member comprises:
a main body portion that covers the opening;
an upper flange portion that extends from an upper end portion of the main body portion in the vehicle width direction and that is fastened in a state superposed on the upper plate portion; and
a lower flange portion that extends from a lower end portion of the main body portion in the vehicle width direction and that is fastened in a state superposed on the lower plate portion.
